(19) United States
(12) Patent Application Publication
(10) Pub. No.: US 2008/0148046 A1
(43) Pub. Date: Jun. 19, 2008

(54) Real-Time Checking of Online Digital Certificates

(76) Inventor: Bryan Glancey, O'Fallon, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/952,843

(22) Filed: Dec. 7, 2007

Related U.S. Application Data
(60) Provisional application No. 60/869,024, filed on Dec. 7, 2006.

(51) Int. Cl. H04L 9/32

(52) U.S. Cl. 713/156

(57) ABSTRACT

Systems and methods designed to provide for real time checking of digital certificates from a two-factor authorization methodology utilizing a secure operating system on a host computer. The host computer utilizes an encryption methodology on all remaining information in the memory of the host computer. The system allows for real time authentication of a digital certificate prior to any portion of the encrypted information being decrypted, allowing effective real time confirmation of certificate validity prior to an access grant.

### CROSS REFERENCE TO RELATED APPLICATION(S)

This application claims benefit of and priority to U.S. Provisional Application Ser. No. 60/869,024, filed Dec. 7, 2006. The entire disclosure of which is herein incorporated by reference.

### BACKGROUND

1. Field of the Invention

This invention generally relates to systems and methods for data security, specifically to managing authentication using digital certificates with the ability to provide revocation on machines wherein the host operating system is encrypted.

2. Description of the Related Art

Computing is becoming much less constrained by the physical confines of the office in today's modern world. Where it used to be that using a computer to access sensitive information tied the user to a particular desk in a particular office, the rise of portable computing devices and the increased use of networks has meant that a user can now access much of the same material they used to only be able to get at their desk from virtually any location. They can even work on that material, and provide updates back to the office, as if they were at their desks when they are in remote locations. In some cases, even the concept of the user's “desk” has disappeared and even users in an office will need to use whatever machine they are nearest to in order to access the information and carry out their work.

There are numerous remote methodologies used to secure data and provide that only those authorized to access it can do so in such an environment. Many businesses offer remote access using secure websites or other secure network systems which can be accessed from anywhere by anyone, but require a user to provide various authentication data to show that they are a registered and recognized user before providing any sensitive information or data. These types of systems may use generally unknown dial-in numbers, non-published IP addresses or similar methods to provide for less potential traffic from unauthorized users.

Over the last several years many organizations have looked to increase the security of their information. The interest generally centers around two primary areas of security: user identification and authentication, and data encryption. One popular user identification system revolves around use of a multiple item authentication. Instead of a user simply needing to have a single item of authentication, such as having a particular file or a particular password, in order to be authenticated, the user must provide more than one type of authentication information relatively simultaneously. For instance, they need not only have a physical device, but must also have an associated password which is tied both to them as user, and to that specific device. Failure to provide either of the identification forms results in failure of positive identification. One common form of such authentication utilizes smart cards and certificate-based authentication systems such as Certificate Revocation Lists (CRL). In these systems, authentication is essentially self-contained on the smart card which acts as a digital key whereupon entry of the correct password into the correct smart card allows the smart card to provide a certificate the host computer can use to unlock and decrypt data accessible to the host computer.

On the data encryption front, while many businesses choose to only encrypt sensitive data, allowing the machine (but not the encrypted data) to be accessed, even by a non-authenticated user, it is becoming increasingly common to see data encryption systems utilizing Full Disk Encryption (FDE) to inhibit unauthorized access to sensitive data. In FDE, all information on a computer, including both the computer's operating system, computer system files, and any user data, is fully encrypted at all times and therefore even if directly accessed, is not useful without proper authentication. In effect, FDE provides that without proper authentication, the entire memory of the computer is unreadable, the computer will not even function as it has no accessible functions prior to authentication as its operating system is part of the encrypted material.

The use of smart cards provides an organization with a centrally managed authentication mechanism which is also two-factor, since the user must have both the card and the password for the card to successfully authenticate their identity. Further, this combined with FDE provides strong protection for data as if the host computer is lost, it becomes very difficult for a malicious or simply unauthorized user to falsify authentication, and without authentication, they are generally unable to obtain any data from storage media, sensitive or not. This combination of strong user authentication and encrypted data are able to provide a very high assurance on the security of the organization's data even in mobile devices which may come into the hands of unauthorized users.

As the organization's users are increasingly mobilized with laptop or handheld instead of desktop computers, the ability to perform remote administration on these devices such as sending policy updates and password resets, especially in real-time, has also become an important issue in computing today. The smart card, FDE, and other security solutions must also fit within these administration needs.

There can however, be concerns with such systems. Since most smart card vendors develop their products for Windows (with basic support for other systems such as MacOS, Linux and UNIX), they are able to handle the administration of these functions within the operating system, where the cards will be used. However, when FDE is also installed on the host machine, access to the host operating system (for example, Windows), is not available until after the user has successfully been authenticated.

The importance of centralized administration is such today that any software product, especially one dealing with security, should be able to managed at any time, especially when that product is performing its functions. Further, the inability to update managed security can also present a problem. Specifically, the host computer is often unable to determine if the encryption certificate on the smart card has been revoked or otherwise updated since the smart card was last used because the authorization requirements are self-contained on the smart card itself, and they cannot be updated prior to the smart card being updated via a host machine. This therefore means that access the FDE memory is granted by the host machine, even if that smart card has been revoked, as the authorization is effectively self-contained on the smart card and because the host computer had no way of obtaining updated information which could indicate a change of authorization (to non-authorized) prior to the host operating system (part of the encrypted memory) becoming available. Therefore, so long as the password is correct in combination with the smart card, the certificates and keys are obtained allowing access to encrypted material before the host computer can determine that a user's access has changed.

This presents a problem when a certificate and user have been revoked and there is concern that the now unauthorized user will be able to access the system. Such access, even if brief, can allow installation of malicious software or of programs which can inhibit the relocking of the host computer, allowing the unauthorized user to access sensitive data. A certificate may have been revoked because an employee was terminated, or because the card was lost, stolen, or otherwise compromised in a fashion that an unauthorized user may have access to it. While the password is still needed in these situations, the password may be known by the unauthorized party or obtainable by conventional means. For example, the employee will still know their password after termination, and, in a theft case, the employee may have written the password on the card, chosen an easy to guess password, or otherwise may have provided the password to the third party. In one scenario, the password may also be able to be obtained by the third party through brute force hacking.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are authorization systems and methods which utilize real time checking with Online Certificate Status Protocol servers (OCSPs) prior to granting access in a two-factor authentication system on a host computer utilizing encryption of the host operating system. In this way, a certificate cancellation will be recognized prior to access to a hose computer being granted and can be used to restrict access, even if the cancellation occurred relatively recently. This allows access to be inhibited as soon as that is indicated to be desired or necessary and inhibits an unauthorized user from gaining access to encrypted data by utilizing a terminated, but previously authorized, access.

There are described herein, among other things, a computer system for implementing real time checking of authorization revocation comprising: a host computer, the host computer including a memory having a secure operating system and the remainder of the memory being in an encrypted section which is protected by encryption; a smart card, the smart card providing for password authentication and retrieval of a digital certificate, from the smart card wherein the digital certificate is useable to decrypt the encrypted section of the memory; and a security server, the security server being accessible by the secure operating system via a network; wherein, when the host computer is started up, the secure operating system operates the host computer; wherein, when the secure operating system obtains the digital certificate from the smart card, the secure operating system transmits the certificate to the security server for authentication prior to decrypting any portion of the encrypted section; and wherein only after the security server verifies the certificate, the certificate is used to decrypt at least a portion of the encrypted section.

In an embodiment of the system the host computer comprises a laptop computer or a handheld computer, the security server is in contact with a directory server and a certificate server, the directory server and the certificate server both having to authenticate the certificate prior to the security server indicating authentication of the certificate to the host computer.

In another embodiment of the system, the security server and the secure operating system are controlled by an entity other than that which controls the host computer.

In another embodiment of the system the encrypted section includes a host operating system, the host operating system being a different operating system to the secure operating system, wherein the data in the encrypted section may be decrypted only on demand for the data by the host operating system.

There is also described herein, a method for implementing real time checking of authorization revocation, the method comprising: providing a host computer, the host computer including a memory including a secure operating system and the remainder of the memory being in an encrypted section which is protected by encryption; providing a security server accessible by the secure operating system via a network; activating the host computer; having the secure operating system request a digital certificate from a successful two-factor authentication, prior to decrypting the encrypted section; the secure operating system transmitting the certificate to the security server via the network for authentication prior to decrypting any portion of the encrypted section; the security server verifying the certificate and transmitting the verification to the host computer via the network; and only after the security server verifies the certificate to the secure operating system, the secure operating system using the certificate to decrypt at least a portion of the encrypted section.

In an embodiment of the method the host computer comprises a laptop computer or a handheld computer, the security server may be in contact with a directory server and a certificate server, the directory server and the certificate server both having to authenticate the certificate prior to the security server indicating authentication of the certificate to the host computer.

In another embodiment of the method, the security server and the secure operating system are controlled by an entity other than that which controls the host computer.

In another embodiment of the method the encrypted section includes a host operating system, the host operating system being a different operating system to the secure operating system, wherein the data in the encrypted section may be decrypted only on demand for the data by the host operating system.

There is also described herein a computer-readable memory storing computer-executable instructions for operating an endoscope integrity tester, the memory comprising: a first section, which is not encrypted; a second section, which is encrypted; computer-executable instructions in the first section requesting a digital certificate from a successful two-factor authentication; computer-executable instructions in the first section for transmitting the certificate to the security server via the network for authentication prior to decrypting any portion of the encrypted section; computer-executable instructions in the first section for receiving from the security server a verification of the certificate; computer-executable instructions in the first section for using the certificate to decrypt at least a portion of the encrypted section only after the verification from the security server is received; and computer-executable instructions in the second section for operating a computer including the memory.

In an embodiment of the memory the computer comprises a laptop computer or a handheld computer, and the security server may be in contact with a directory server and a certificate server, the directory server and the certificate server both having to authenticate the certificate prior to the security server indicating authentication of the certificate to the host computer.

In another embodiment of the memory the security server is controlled by an entity other than that which controls the computer.

In a still further embodiment of the memory, data in the encrypted section is decrypted only on demand for the data by the instructions in the second section.

### BRIEF DESCRIPTION OF THE DRAWINGS

FIG. 1 provides a flowchart of the operation of the verification methodology in online and offline environments.

FIG. 2 provides a general block diagram of the arrangement of servers and clients in an embodiment of a system allowing real-time checking of digital certificates in an FDE encrypted system.

FIG. 3 provides a general block diagram showing a conceptual indication of how data blocks are stored in memory.

### DESCRIPTION OF THE PREFERRED EMBODIMENT(S)

The following detailed description illustrates by way of example and not by way of limitation. Described herein, among other things, is an embodiment of a computer network and operational system whereby a host computer utilizing traditional Full Disk Encryption (FDE), or, more specifically, which has the host operating system encrypted, can perform real-time analysis of authorization status of a two-factor authentication system to detect the use of a previously revoked authentication certificate via the use of a pre-boot operating system environment separate from the encrypted host operating system which can access sensitive data.

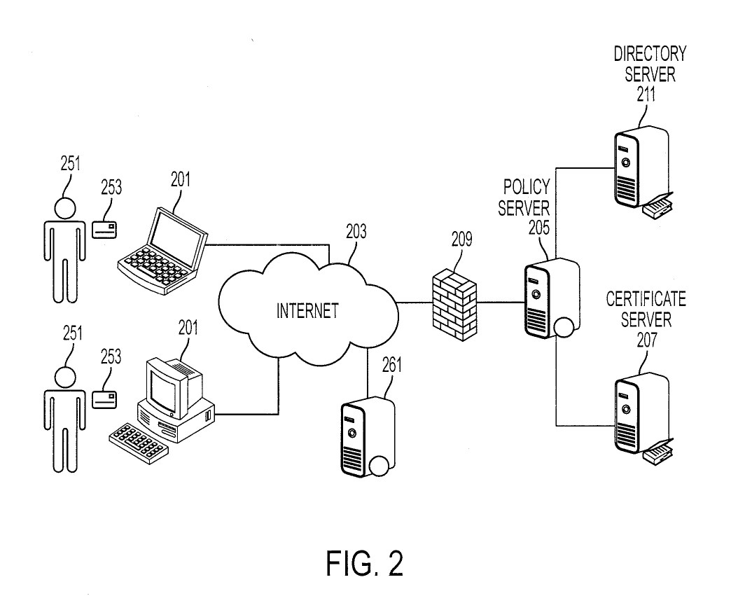

In the embodiments discussed herein there are a number of terms which will be used to refer to parts and operators of the system. Generally, these parts are defined by their operation. So as to present a basic overview of the nature of authentication, the major components of the secured system are discussed first. The reader is invited to follow the following paragraph in conjunction with FIG. 2.

A “user” (251) will be an individual which has presented a smart card (253) for purposes of their authentication as an authorized user to a “host computer” (201) which is a device capable of obtaining sensitive data. This data may be within the memory of the host computer (201), or may be available from a remote “data server” (261) which the host computer can access on behalf of authorized users. Such access is generally through a network such as the Internet (203). Both the data server (261) and usually the host computer (201) will usually be controlled by an “owner” (not shown) which will often comprise a corporation or similar business entity having the users (251) as its employees.

In the discussed security implementations, the combination of a physical object and a memorized password is used to authenticate a user's (251) identity. Many are familiar with such an implementation when using an Automatic Teller Machine (ATM) where a unique physical card must be presented in combination with a Personal Identification Number (PIN) to access an account. In computer systems, this general concept can be implemented through the use of a Common Access Card (CAC) or similar device, which includes smart card (253) functionality and associated credentials for use in authentication. In order to authenticate using the smart card (253), the user (251) must present the smart card (253) containing their credentials as well as know the PIN number or password which unlocks the credentials on the smart card (253) so that they can be used, thus providing “two-factor” authentication.

Generally two-factor authentication relates to any type of authentication where two separable items must both be presented to authenticate the user (251). In the above, the two factors are something they have (the smart card), and something that they know (the password). Two-factor authentication is mandated under several sets of federal regulations for use by federal employees and may be used by private sector entities as well. Throughout this disclosure, the discussed embodiments will utilize a two-factor authentication comprising a smart card (253) and password combination. This should be recognized as a merely exemplary embodiment of a two-factor authentication, however, it is a particularly useful one as the smart card (253) can include processing sufficient to allow authentication of the two-factor combination on an FDE host computer (201) where the host computer (201) is generally incapable of operating due to its host operating system (431) being encrypted prior to authentication of the user (251). Effectively, the smart card (253) implementation allows the certificate retrieval process to be relatively self-contained on the physical component used in the authentication.

Traditionally, the self-contained nature of the authentication provided for a significant weakness in that the card could only have authorization lists updated once the host computer (251) was accessed and decrypted but self-contained authorization was necessary since the host operating system (431) was encrypted and not available until after authentication was successful.

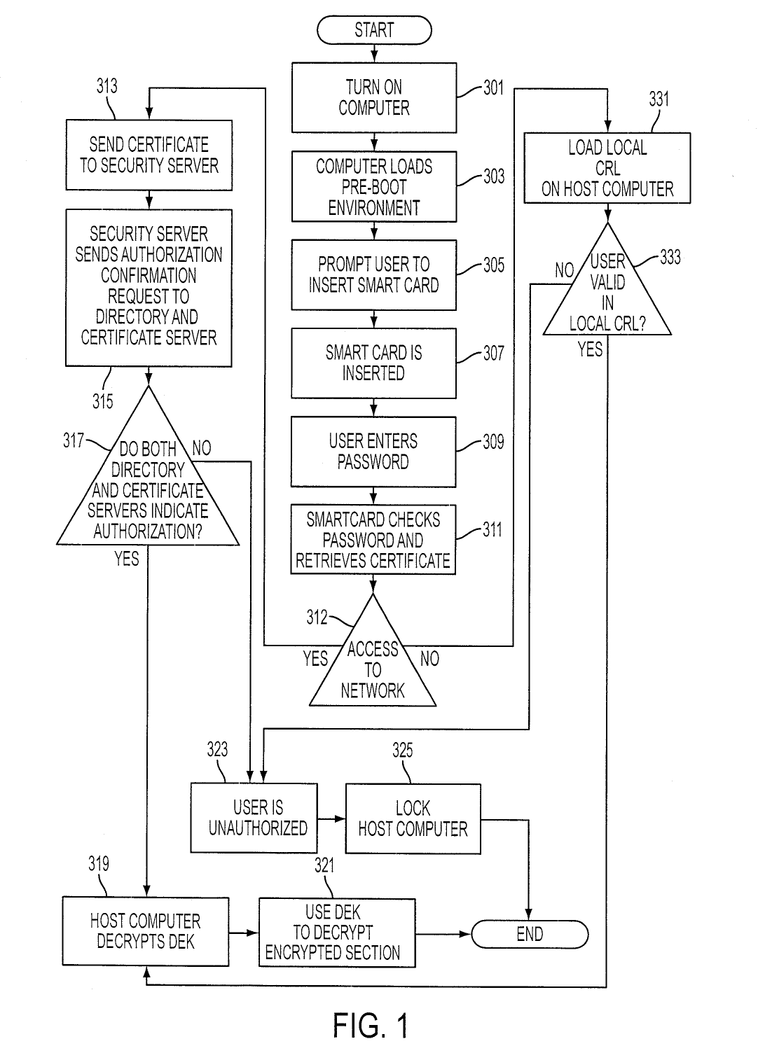

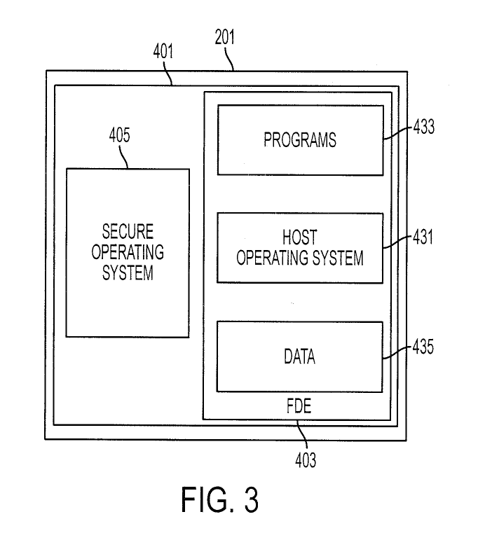

In an embodiment of the present security system, as indicated in FIG. 3, two-factor authentication operates inside a secure pre-boot authentication environment on the host computer (201) where sensitive data and the related host operating system (431) is essentially unusable until identity and authorization have been verified. In particular, such a system provides what is traditional Full Disk Encryption (FDE), requiring authentication prior to access of any data (435) programs (435) or even the host operating system (431) of the host computer (201). Instead access on the host computer (201) is limited to a secure operating system (405) designed to authenticate, and which is generally unable to access anything encrypted until after authentication. In such an embodiment, this access is implemented using a process such as that shown in the flowchart of FIG. 1. As can be seen in FIG. 1 the system will generally utilize an approach to authentication based on its ability to access a remote server to obtain real time updates prior to the host computer (201) becoming accessible to the user (231).

In order to provide for the secure authentication system, in an embodiment, there will generally be provided a network system as shown in FIG. 2. In FIG. 2 there are provided host computers (201) representing machines which are available to users (251) to access sensitive data. These host computers (201) will often be mobile computers or other devices which do not require any form of direct connection to be used to access material either stored locally on their memory or from a data server (261) or other remote location via a network such as the Internet (203). These host computers (201) will generally include a memory. The memory (401) is shown in an abstract form in FIG. 3 and includes a host operating system (431) (such as, but not limited to Microsoft Windows™, Linux, Unix, or MacOS), which allows the host computer to operate and to perform expected computing functions, programs (433) which are designed to allow the performance of particular functions within the operating system (431), and data (435) comprising material which is used by the user (251) in performing their function for the owner.

It will generally be recognized that the vast majority of host computers (201) will include as part of their programs (433) and data (435), functionality which allows them to interact with other computers via networks such as the Internet (203). Further, some host computers (201) will have limited to no functionality without such a connection as data (435) and/or programs (433) may be provided via the network connection and not residing on the host computer (201). Network access functionality can include web browsers or more specialized functions such as virtual private network (VPN) software, or file sharing software. These programs (433) operate within the host operating system (431) environment and allow the host computer (201) to access information on other computers via hardware that allows connection to the network (203) such as network cables, modems, or wireless network adapters.

In many environments, sensitive data (435) is not stored on the host computer (201) directly, but is instead accessible via the network (203) when a host computer (201) indicates, via the network (203), that a user (251) is authorized to access sensitive data via a network (203). In this way, the host computer (201) will generally first determine that its user is authorized to operate the host computer (201) and access material on the network, and then indicate via the network (203) to a server (261) which stores the sensitive data, that the host computer (201) can receive such data via the network because it is a machine authorized to have such access, and its user is authorized for such access. The transmission of such data is generally encrypted to prevent interception while it is between the data server (261) and the host computer (201).

In prior systems, the problem arises that the host computer (201) can only determine that a user's (251) authorization to access has expired after the user (251) has been verified to the host computer (201) and the host operating system (431) is running because the host operating system (431) is necessary for network access programs (433) to be used and those programs (433) are in turn necessary to allow the host computer (201) to receive security updates such as indications of newly revoked access privileges. Effectively upon indication to the data server (261) that a previously authorized, but now unauthorized, user (251) is logged in, the data server (261) can indicate to the host computer (201) to deny access. The host computer (201) can then shut down or otherwise lock out the user (251) by updating that user's (251) status within its own internal memory or the memory of the smart card (253) used to access the host computer (201). This creates a potential security hole as an unauthorized user (251) has at least brief access to the host computer (201) and data server (251) before they are locked out, at which time they may be able to execute programs which inhibit the host computer (201) from locking them out.

In an embodiment of the present system, the host computer (201) provides for security updating prior to access being granted to data (425) and the host operating system (431) by having two separate operating systems and effectively two parts of memory as shown in FIG. 3. There is an encrypted section (403) and a secure operating system section (405). The encrypted section (403) includes the host operating system (431) which generally is the operating system for all functions except security and which allows access and use of data (433). Associated with the encrypted section (403) are programs (433) and data (435). All of this material, however, is provided with encryption so that it is stored in an encrypted form and unusable until the authorization of the user has been verified. In addition to this host operating system (431), there is a secure pre-boot operating system (405) which is designed to interface with a security server (205) and with the smart card (253) to perform authentication steps and is not encrypted in the same fashion as the encrypted section (403). This secure operating system (405) will, therefore, generally be separate and different from the main operating system (431) of the host computer (201) so that it can be provided with limited specific functionality related to user authentication and not useable to use or operate the host computer (201) outside of that limited functionality.

In an embodiment, the network (203) environment in which the host computer (201) operates to perform security verification will include a remote security server (205) which is accessible from the client (201) via the Internet (203) or other network and which acts as an updating system and gatekeeper for authorization. The security server (205) will generally not be the same server as the data server (261) which is under control of the owner and provides data to the host computer (201). Instead, the security server (205) is designed to only provide authorization information and allows administration of the host computer (201) even while the host operating system (431) is encrypted by interfacing only with the secure operating system (405). Thus, the secure operating system (405) prevents access to the host operating system (431) and anything in encrypted section (403) until after the user is authenticated via a real time check of the authorization by the secure operating system (405) with the security server (205).

The secure operating system (405) is therefore able to communicate with the security server (205) and apply new security policy updates and other configuration changes to the client (201) prior to authentication of the user and encryption of encrypted section (403). In such a way, modification of authorization systems (such as revocation of the smart card (253) being used as belonging to an authorized user) can occur prior to any portion of the encrypted data (403) on the host computer (201) being decoded. Therefore, smart card users (251) can be verified against the security server (205) instead of only providing local, cached verification so long as network (203) connectivity is available. In this way, the attempted use of a smart card (251) which has been revoked, but whose internal information still believes itself to be valid, can be stopped from accessing any of the encrypted data (403) on the host computer (201), or in fact in using the host computer (201) in any way beyond attempting authorization.

By using an independently maintained and reviewed secure operating system (405) to perform the authentication procedure, the authorization requirements can also easily accommodate changes in the host computer's (201) environment, programs, or data, including the addition of new technologies, without relying on the need for developers associated with an owner to need to adapt their internal operation to accommodate the authorization procedures. In effect, the host computer's (206) owner is responsible for the encrypted section (403) which is separate from the secure operating system (405) and operates independently of the secure operating system (405).

For example, should the owner change operating systems for its host computers (201), the secure operating system (405) is unchanged as it is separate and therefore the authorization systems and methods need not be altered by the owner (or even understood by the owner). The owner effectively only works with the encrypted section (403) which is equivalent to a prior computer using FDE. The owner will modify operating system (431) and any associated programs and data (433) and (435) portions of the memory. Since the secure operating system (405) can provide support for sufficient network access for authorization, and generally only operates for authorization, the host computer (201) does not need to rely on the host operating system (431) for administration. The secure operating system (405) is able to contact the server (205) itself and avail itself to updated policy and user information in real-time prior to user authentication completely independent of the host operating system (431) or in fact any portion of the encrypted memory section (403).

In a preferred embodiment, the status of various users authorized to use on the host computer (201) is maintained using Online Certificate Status Protocol (OCSP). OCSP provides that changes made by the organization to alter authorization rights can be updated in real-time in a network (203). Thus, detection of certificate revocation during the login occurs in real time. This removes the necessity of maintaining and downloading Certificate Revocation Lists (CRL) to the host computer (201) or smart card (253) for checking the status of a certificate on the smart card (253) by instead checking against the security server (205) for the information prior to access of the encrypted section (403). Further, because of the real-time availability of information from the security server (205), a user (201) which has a revoked authorization is not granted any access other than to the secure operating system (405) which, as discussed above, is separate from and unable to provide functionality beyond authorization. However, in an embodiment, the system will still utilize a more compact version of a CRL to handle offline authorization if such authorization is necessary.

Continuing with the embodiment of FIG. 2, the host computer (201) which includes an encrypted section (403) and secure operating system (405) is activated and access to the encrypted section (403) is requested. The secure operating system (405) accesses the security server (205) which serves as an administrative server Security server (205) will generally act as a pass-through proxy for all online authentication attempts by a host computer (201). For example, a user authenticating to a domain controller (such as Active Directory) will have the authentication request securely transmitted from the host computer (201) to the server (205) where it will be authenticated by the domain controller. The server (205) will then present the host computer (201) with approval or rejection indications associated with the user of the certificates selected by two-factor authorization. The security server (205) will generally include protection from the Internet such as firewall (209). The security server (205) also has access to a directory server (211) which serves as an authentication server for the owner, such as active directory, and a certificate server (207) which generates and maintains the owner's certificates. From this certificate server new smart cards (253) (and hence identity certificates) could be created, and they could also be revoked. This certificate server (207) will generally support OCSP or a similar protocol.

It is important to note that the exact configuration of the directory (211) and certificate servers (207) and their interaction with the security server (205) will vary depending on specific products used, and the desires of the owner. For example, the directory (211) and/or certificate server (207) may be provided by someone other than owner or may be the same physical machine as each other and/or the data server (261) depending on embodiment.

FIG. 1 illustrates how the system of FIG. 2 can be used, in an embodiment, to authenticate a user. This example is used to illustrate the general flow of the solution in a generic environment and should not be taken as limiting to any particular operation or software requirements.

The embodiment will generally operate in two key environments: online and offline, as determined by whether the host computer (201) has network access during the user login. These two environments represent the two halves of the flowchart of FIG. 1.

In the online environment, the host computer (201) is able to connect to the Internet or other network and hence to the server (205). The server (205) is therefore the conduit for all host computer (201) communications. When a user (251) logs into the host computer (201), the authentication request is packaged and sent to the server (205). The server (205) then queries the certificate server (207) to validate the authentication request. The success or failure message is then packaged and sent back to the client.

Specifically, the data flow of FIG. 1 occurs as follows: a user (251) initiates the computer transaction by turning on the host computer (201) in step (301). The computer loads the pre-boot environment in step (303), which will generally recognize whether the host computer (201) is online or offline as contemplated below. The pre-boot environment generally including drivers for PCMCIA port, USB port, and specific drivers for the smart card reader being used by the user. The host computer (201) will prompt for insertion of the smart card (253) in step (305) if it is not already present. When the user presents the smart card (253) in step (307) and the password is entered in step (309), the host computer (201) will proceed to obtain the encryption certificate from the smart card (253) in step (311).

This example presumes that the smart card (253) and password combination was valid as of the immediately prior time the smart card (253) was used to authenticate on the host computer (201) and therefore, internally the smart card (253) is valid for authenticating and returns the certificate.

The form of verification available now depends on if the host computer (201), via the secure operating system (431), has access to network (203) in step (312). If it does (the host computer (201) is in “online” mode), prior to this certificate being used to decrypt the encrypted section (403) of the host computer (201), the certificate will be verified to the certificate server (207) in step (313). This communication is generally protected using device-specific keys to avoid it being intercepted and presenting a security hole. The security server (205) will send the credentials to the directory server (211) to verify the user is authentic and currently valid. The security server (205) will also send the certificate information to the certificate server (207) using OCSP to verify the certificate itself is current and not revoked or otherwise invalid. Both of these sends occur in step (315). The security server (205) receives the responses in step (317) and determines if the certificate is still valid. The security server (205) then packages the responses and sends them back to the host computer (201). If the user credentials are valid and the certificate is valid in step (317), the certificate will now be used by the host computer (201) to decrypt the Device Encryption Key (DEK) on host computer (201) in step (319). The host computer (201) can then use the DEK to decrypt the encrypted section (403), allowing the host computer (201) to boot up and the user (251) to access the encrypted section (403) of the host computer (201), generally as data (435) accessed (on-the-fly) in step (321).

If either the directory (211) or certificate server (207) returns a rejected notification, the encrypted portions of the host computer (201) will remain in an encrypted state as the host computer indicates that the access is unauthorized in step (323) and the host computer (201) may become locked, possibly refusing to return the smart card (253), triggering alarms or taking other steps, and ending the process so as to prevent the access in step (325).

Since this is a live network environment where the user (251) is authenticated, changes that have occurred, such as the revocation of the user's (251) smart card (253) (such as would occur when the smart card (253) is lost or stolen), will take effect immediately upon the certificate (207) and/or directory server (211) being updated with the change in status. As soon as the person having the lost or stolen smart card (253) attempts to login, the host computer (201) will connect to the server (205) to download any new policies as well as passing on all authentication attempts. Therefore so long as the change has been entered in any of the servers (205), (207) or (211), the change will be known to the host computer (201) prior to the user (251) being authenticated, leaving all the encrypted section (403) of the memory encrypted and secure.

It should be recognized that the real time checking does require the client (201) to have network (203) access so as to access the security server (205). Since there may be times when a host computer (201) cannot connect to the security server (205) (such as when used outside a network (203) environment), the online operation of the system may not always be available. However, it may be possible to still allow at least limited access to the host computer (201) and some security in such situation. In this case, all validation must be done locally on the host computer (201) as no network (203) connection is available.

The host computer (201) and the security server (205) “plan” for this case by providing an offline authentication protocol on the host computer (201) itself. This protocol is only invoked when it is not possible for the host computer (201) to communicate to the security server (205). The offline system is comprised of two systems: a cached credential authentication system and a local Certificate Revocation List.

In offline mode, the initial steps occur similarly as to the online mode. However, in step (312) the offline path where there is no network availability is followed. As there is no network access, the secure operating system (405) will load a local Certificate Revocation List (CRL) on host computer (201) in step (331) and determine if the certificate is valid in the local CRL in step (333).

Assuming the CRL comparison indicated the certificate was valid on host computer (201), the host computer (201) in step (319) will again decrypt the Device Encryption Key (DEK) using the information from the smart card (253) along with a username provided by the user. If this is successful, the DEK, in step (321) is used to decrypt information in the encrypted section (403) as it is requested by the user maintaining information not immediately in use in encrypted format. If the CRL returns an invalid indication, the user again is unauthorized in step (323) and the host computer (201) may lock out the user in step (325).

The cached credential authentication system used in the offline situation may be updated every time the user successfully authenticates the host computer (201) in the online system so as to maintain the most up-to-date CRL on the host computer (201). The host computer (201) therefore stores an encrypted version of the latest credentials to be used the next time a user (251) logs in where there is no network (203) access. Along with the cached credentials may be stored any information regarding password changes that must occur, such that the user (251) will be required to change their password as scheduled, regardless of being in a disconnected state. Both the CRL and any such mandatory updates may be part of the secure operating system (405).

The local CRL is not generally a complete CRL download in the traditional sense. The security server (205) queries the certificate server (207) for an updated CRL only for those users (251) authorized to use the host computer (251) (which may only be a single user in some cases). This provides a much smaller list of certificates to validate than the complete CRL, and provides the intelligence that is lacking in a traditional CRL method for providing the list of revoked certificates. This CRL includes all current and revoked certificates for any users (251) authorized to access the host computer (201). As all other users (251) would not be considered valid, their certificate status is not included and therefore the list of possible users (251) to access the host computer (201) is restricted, making the system generally more secure. This list is built by the security server (205) at a pre-defined interval (e.g. at every login or once a week or every couple of days), and downloaded to the client only if changes have been made (i.e. new certificates have been added or revoked).

The differences then, between online and offline authentication are based on where the validation occurs of the user (251) credentials and smart card (253) certificate, but the communications and methods are generally similar. The next time the host computer (201) is able to connect to the security server (205) the information would be updated.

It is important to note that in both the online and offline environment, other security controls, such as locking user accounts after successive failed password entries, will generally still be in effect if used. Further, if sensitive information is not stored on the host computer (201), but is accessible to the host computer once the user (251) is logged in, the data can be inhibited from use by an unauthorized user (251) even in an office by not allowing access to the data online, until the online authentication has occurred. In effect, if the user (251) needs the online environment to access the sensitive data, the updated revocation of access will occur before such online access is granted even if the user (251) was originally logged in while offline. Thus, while the user (251) can access the locally encrypted section (403), they cannot access anything online for precisely the same reason the online check was not performed, limiting their access even further.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A computer system for implementing real time checking of authorization revocation comprising:
a host computer, the host computer including a memory having a secure operating system and the remainder of the memory being in an encrypted section which is protected by encryption;
a smart card, said smart card providing for password authentication and retrieval of a digital certificate, from said smart card wherein said digital certificate is useable to decrypt said encrypted section of said memory; and
a security server, said security server being accessible by said secure operating system via a network;
wherein, when said host computer is started up, said secure operating system operates said host computer;
wherein, when said secure operating system obtains said digital certificate from said smart card, said secure operating system transmits said certificate to said security server for authentication prior to decrypting any portion of said encrypted section; and
wherein only after said security server verifies said certificate, said certificate is used to decrypt at least a portion of said encrypted section.

2. The system of claim 1 wherein said host computer comprises a laptop computer or a handheld computer.

3. The system of claim 1 wherein said security server is in contact with a directory server and a certificate server, said directory server and said certificate server both having to authenticate said certificate prior to said security server indicating authentication of said certificate to said host computer.

4. The system of claim 1 wherein said security server and said secure operating system are controlled by an entity other than that which controls said host computer.

5. The system of claim 1 wherein said encrypted section includes a host operating system, said host operating system being a different operating system to said secure operating system.

6. The system of claim 5 wherein data in said encrypted section is decrypted only on demand for said data by said host operating system.

7. A method for implementing real time checking of authorization revocation, the method comprising:
providing a host computer, said host computer including a memory including a secure operating system and the remainder of the memory being in an encrypted section which is protected by encryption;
providing a security server accessible by said secure operating system via a network;
activating said host computer;
having said secure operating system request a digital certificate from a successful two-factor authentication, prior to decrypting said encrypted section;
said secure operating system transmitting said certificate to said security server via said network for authentication prior to decrypting any portion of said encrypted section;
said security server verifying said certificate and transmitting said verification to said host computer via said network; and
only after said security server means verifies said certificate to said secure operating system, said secure operating system using said certificate to decrypt at least a portion of said encrypted section.

8. The method of claim 7 wherein said host computer comprises a laptop computer or a handheld computer.

9. The method of claim 7 wherein said security server is in contact with a directory server and a certificate server, said directory server and said certificate server both having to authenticate said certificate prior to said security server indicating authentication of said certificate to said host computer.

10. The method of claim 7 wherein said security server and said secure operating system are controlled by an entity other than that which controls said host computer.

11. The method of claim 7 wherein said encrypted section includes a host operating system, said host operating system being a different operating system to said secure operating system.

12. The method of claim 11 wherein data in said encrypted section is decrypted only on demand for said data by said host operating system.

13. A computer-readable memory storing computer-executable instructions for operating an endoscope integrity tester, the memory comprising:
a first section, which is not encrypted;
a second section, which is encrypted;
computer-executable instructions in said first section requesting a digital certificate from a successful two-factor authentication;
computer-executable instructions in said first section for transmitting said certificate to said security server via said network for authentication prior to decrypting any portion of said encrypted section;
computer-executable instructions in said first section for receiving from said security server a verification of said certificate;
computer-executable instructions in said first section for using said certificate to decrypt at least a portion of said encrypted section only after said verification from said security server is received; and
computer-executable instructions in said second section for operating a computer including said memory.

14. The memory of claim 13 wherein said computer comprises a laptop computer or a handheld computer.

15. The memory of claim 13 wherein said security server is in contact with a directory server and a certificate server, said directory server and said certificate server both having to authenticate said certificate prior to said security server indicating authentication of said certificate to said host computer.

16. The memory of claim 13 wherein said security server is controlled by an entity other than that which controls said computer.

17. The memory of claim 13 wherein data in said encrypted section is decrypted only on demand for said data by said instructions in said second section.
